(19) United States
(12) Patent Application Publication
(10) Pub. No.: US 2025/0294622 A1
(43) Pub. Date: Sep. 18, 2025

(54) METHOD AND APPARATUS FOR ENABLING SYNCHRONIZATION

(71) Applicant: Nokia Technologies Oy, Espoo (FI)

(72) Inventors: Matha DEGHEL, Paris (FR); Keeth Saliya Jayasinghe LADDU, Espoo (FI)

(21) Appl. No.: 18/861,664

(22) PCT Filed: May 6, 2022
(86) PCT No.: PCT/EP2022/062298

§ 371 Date: Oct. 30, 2024

(51) Int. Cl. H04W 74/0838; H04W 72/232

(52) U.S. Cl. CPC H04W 74/0838; H04W 72/232

(57) ABSTRACT

Apparatuses and methods for enabling synchronization are provided. The solution comprises receiving (300), from a network entity, a random-access indication message indicating whether a transmission of at least one physical random access channel, PRACH, uses at least one random access resource corresponding to or associated with one or more network entities, and transmitting (302) the at least one of the PRACH based on the random-access indication message.

### FIELD

The exemplary and non-limiting embodiments of the invention relate generally to wireless communication systems. Embodiments of the invention relate especially to apparatuses and methods in wireless communication networks.

### BACKGROUND

Wireless communication systems are under constant development. Systems are developed so that new services may be offered to users of the systems. On the other hand, systems are also developed to enable the systems to operate more efficiently, by increasing capacity, connection quality and reducing energy consumption and delays, for example.

In modern wireless communication systems solutions have been developed where terminal devices may communicate with more than one transmission-reception point or be aware of multiple transmission-reception points.

Terminal devices communicating with transmission-reception points need to be synchronized to the transmission points. When a terminal device is associated with more than one transmission-reception point, this may lead problems if synchronization is lost.

### SUMMARY OF SOME EXEMPLARY EMBODIMENTS

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided a method for a terminal device, comprising: receiving, from a network entity, a random-access indication message indicating whether a transmission of at least one physical random access channel, PRACH, uses at least one random access resource corresponding to or associated with one or more network entities, transmitting the at least one of the PRACH based on the random-access indication message.

In an embodiment, the method comprises receiving the random-access indicating message in downlink control information, DCI.

In an embodiment, the transmitted at least one PRACH is using one or more of the at least one random-access resource.

In an embodiment, the random-access resource comprises at least one of: random-access preamble index, synchronisation signal/physical broadcast channel, SS/PBCH, index, random-access channel occasion.

In an embodiment, the random-access indicating message comprises at least a second random-access resource for contention-free random access corresponding to or associated with the one or more network entities.

According to an aspect of the present invention, there are provided a method for a network entity, comprising: obtaining a random-access indication message; transmitting to a terminal device a random-access indication message, wherein the random-access indication message indicates whether a transmission of at least one physical random access channel, PRACH, uses at least one random access resource corresponding to or associated with one or more network entities.

According to an aspect of the present invention, there is provided a apparatus in a terminal device comprising: at least one transceiver, wherein the at least one transceiver is configured to: receive, from a network entity, a random-access indication message indicating whether a transmission of at least one physical random access channel, PRACH, uses at least one random access resource corresponding to or associated with one or more network entities, transmit the at least one of the PRACH based on the random-access indication message.

According to an aspect of the present invention, there is provided an apparatus in a network element comprising: at least one processor; and at least one transceiver, wherein the at least one processor is configured to: obtain a random-access indication message; wherein the transceiver is configured to: transmit to a terminal device the random-access indication message, wherein the random-access indication message indices whether a transmission of at least one physical random access channel, PRACH, uses at least one random access resource corresponding to or associated with one or more network entities.

According to an aspect of the present invention, there is provided a computer program comprising instructions for causing an apparatus to perform at least the following: receive, from a network entity, a random-access indication message indicating whether a transmission of at least one physical random access channel, PRACH, uses at least one random access resource corresponding to or associated with one or more network entities, transmit the at least one of the PRACH based on the random-access indication message.

According to an aspect of the present invention, there is provided a computer program comprising instructions for causing an apparatus to perform at least the following: obtain a random-access indication message; transmit to a terminal device the random-access indication message, wherein the random-access indication message indicates whether a transmission of at least one physical random access channel, PRACH, uses at least one random access resource corresponding to or associated with one or more network entities.

An embodiment provides a computer readable storage medium comprising program instructions for causing an apparatus to perform at least the following: receive, from a network entity, a random-access indication message indicating whether a transmission of at least one physical random access channel, PRACH, uses at least one random access resource corresponding to or associated with one or more network entities, transmit the at least one of the PRACH based on the random-access indication message.

An embodiment provides a computer readable storage medium comprising program instructions for causing an apparatus to perform at least the following: obtain a random-access indication message; transmit to a terminal device the random-access indication message, wherein the random-access indication message indicates whether a transmission of at least one physical random access channel, PRACH, uses at least one random access resource corresponding to or associated with one or more network entities.

An embodiment provides an apparatus comprising means for receiving, from a network entity, a random-access indication message indicating whether a transmission of at least one physical random access channel, PRACH, uses at least one random access resource corresponding to or associated with one or more network entities and means for transmitting the at least one of the PRACH based on the random-access indication message.

An embodiment provides an apparatus comprising means for obtaining a random-access indication message and transmitting to a terminal device the random-access indication message, wherein the random-access indication message indicates whether a transmission of at least one physical random access channel, PRACH, uses at least one random access resource corresponding to or associated with one or more network entities.

One or more examples of implementations are set forth in more detail in the accompanying drawings and the description below. Other features will be apparent from the description and drawings, and from the claims. The embodiments and/or examples and features, if any, described in this specification that do not fall under the scope of the independent claims are to be interpreted as examples useful for understanding various embodiments of the invention.

### BRIEF DESCRIPTION OF THE DRAWINGS

Embodiments of the present invention are described below, by way of example only, with reference to the accompanying drawings, in which

FIG. 1 illustrate an example of simplified system architecture of a communication system;

FIG. 2 illustrates an example of a Multi-Transmission-Reception Point (M-TRP) situation;

FIG. 3A is a flowchart illustrating an embodiment;

FIG. 3B is a flowchart illustrating an embodiment;

FIG. 4A is a signalling chart illustrating an embodiment;

FIG. 4B is a signalling chart illustrating an embodiment;

FIG. 5 illustrates an example of an apparatus;

FIG. 6A illustrates an example of an apparatus; and

FIG. 6B illustrates an example of an apparatus.

### DETAIL DESCRIPTION OF SOME EMBODIMENTS

The following embodiments are only presented as examples. Although the specification may refer to “an”, “one”, or “some” embodiment(s) and/or example(s) in several locations of the text, this does not necessarily mean that each reference is made to the same embodiment(s) or example(s), or that a particular feature only applies to a single embodiment and/or example. Single features of different embodiments and/or examples may also be combined to provide other embodiments and/or examples.

In the following, different exemplifying embodiments will be described using, as an example of an access architecture to which the embodiments may be applied, a radio access architecture based on long term evolution (LTE) or new radio (NR) of the fifth-generation technology standard for broadband cellular networks (5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks 15 (MANETs) and Internet Protocol multimedia subsystems (IMS) or any combination thereof.

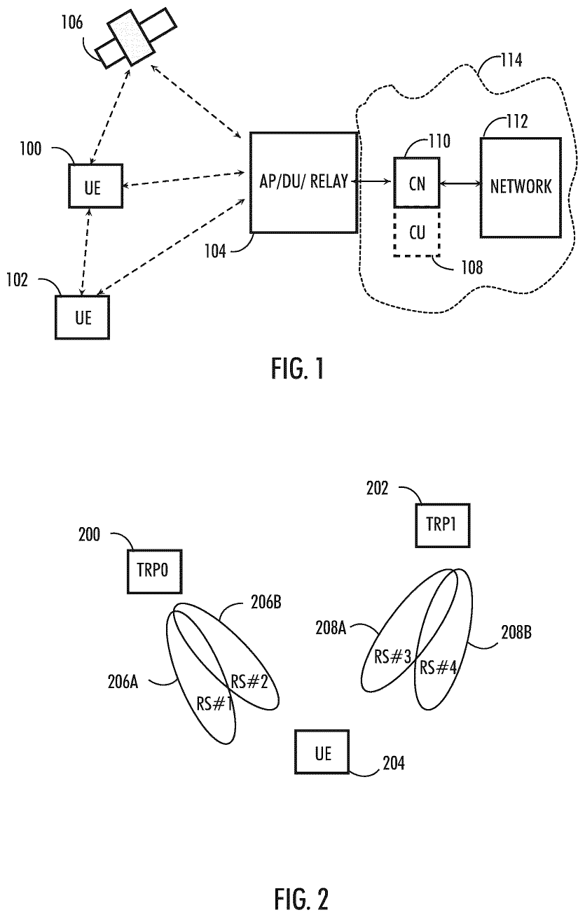

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g) NodeB) 104 providing the cell. The physical link from a user device to a eNodeB or gNB is called uplink or reverse link and the physical link from the eNodeB or gNB to the user device is called downlink or forward link. It should be appreciated that eNodeBs or gNB or their functionalities may be implemented by using any node, host, server or access point etc. entity suitable for such a usage.

User device 100 and 102 in the present disclosure may be referred as user equipment. User device may be terminal device which could be used or integrated in any kind of equipment.

A communications system typically comprises more than one eNodeB or gNB in which case the eNodeBs or gNBs may also be configured to communicate with one another over links, wired or wireless, designed for the purpose. These links may be used for signalling purposes. The eNodeB or gNB is a communication device configured to control the radio resources of communication system it is coupled to. The NodeB may also be referred to as a base station, an access point or any other type of interfacing device including a relay station capable of operating in a wireless environment. The eNodeB or gNB includes or is coupled to transceivers. From the transceivers of the eNodeB or gNB, a connection is provided to an antenna unit that establishes bi-directional radio links to user devices. The antenna unit may comprise a plurality of antennas or antenna elements. The eNodeB or gNB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable communication device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, vehicle, note-book, and multimedia device.

It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

It should be understood that, in FIG. 1, user devices are depicted to include 2 antennas only for the sake of clarity. The number of reception and/or transmission antennas may naturally vary according a current implementation.

Additionally, although the apparatuses have been depicted as single entities, different units, processors and/or memory units (not all shown in FIG. 1) may be implemented.

It is obvious for a person skilled in the art that the depicted system is only an example of a part of a radio access system and in practice, the system may comprise a plurality of eNodeBs or gNBs, the user device may have access to a plurality of radio cells and the system may comprise also other apparatuses, such as physical layer relay nodes or other network elements, etc.

As mentioned, solutions have been developed where terminal devices may communicate with more than one transmission-reception point or be aware of multiple transmission-reception points, TRPs. The TRPs can be access nodes (eNode B, gNode B), remote radio heads or remote distributed units, for example.

FIG. 2 illustrates an example of a Multi-Transmission-Reception Point (M-TRP) situation. In the figure there are two transmission-reception points TRP0 200 and TRP1 202 and a terminal device 204. In the M-TRP example of FIG. 2, there are two TRPs, but the number of TRPs is not limited to two. TRP0 200 transmits two beams 206A, 206B with Channel State Information-Reference Signals CSI-RS #1 and CSI-RS #2. TRP1 202 transmits two beams 208A, 208B with Channel State Information-Reference Signals CSI-RS #3 and CSI-RS #4.

In an embodiment, the TRP0 operates a first cell having a Physical Cell ID PCI #0 and TRP1 operates a second cell having a Physical Cell ID PCI #1. For example, the terminal device 204 may be in Radio Resource Control, RRC, connection with TRP0 200. TRP1 202 does not have an RRC connection with the terminal device but is transmitting Physical Downlink Control Channel, PDCCH, which may associate for example with downlink control information (DCI), to the terminal device. The cell PCI #0 of TRP0 may be denoted as serving cell and the cell PCI #1 of TRP1 may be denoted as an inter-cell mTRP cell or a cell configured for inter-cell multi TRP communication for UE. In some cases, the cell PCI #1 of TRP1 this may be referred to as “non-serving cell”. However, the M-TRP configuration of the PCI #1 or the non-serving cell is still part of the serving cell configuration (PCI #0).

In an embodiment, M-TRP operation may be implemented in such a manner that there may be different control resource sets, CORESETs associated to specific TRPs using a CORESETPoolIndex parameter. CORESETs associated with TRP0 may have been given a poolIndex (such as CORESETPoolIndex #0 for example) and CORESETs associated with TRP1 have a been given different poolIndex (such as CORESETPoolIndex #1 for example). Thus, in some embodiments, to determine that multi TRP communication is configured, UE may determine if there are more than one (e.g. two or more) distinct CORESETpoolIndex values configured for CORESETs.

If a terminal device in connected state has been inactive, i.e., not performed any uplink transmissions for a certain time, the synchronization to the network may be lost. If the network detects such a loss of uplink synchronization it may trigger a random access transmission from the terminal device by means of a so-called physical downlink control channel PDCCH order. The PDCCH order may be provided using downlink control information, DCI.

The PDCCH order may trigger a contention-free random access, CFRA, procedure or a contention-based random access, CBRA, procedure. The DCI may carry an indication to indicate whether CFRA or CBRA should be used.

To obtain synchronization to the network, the terminal device may adjust timing advance, TA, of its transmission. The TA may depend on the distance of the terminal device to the serving base station or the propagation delay between the terminal device and the base station.

In case of a terminal device is involved in multi-TRP, applying a single TA does not enable it to communicate with more than one TRP. Because of possible difference in propagation delays between TRPs (for both inter-cell and intra-cell multi-TRP) and the synchronization precision between TRPs, it may not be possible to guarantee that uplink signals from the terminal device towards different TRPs are within the length of cyclic prefix if a single TA is used. Thus, relying on a single TA for uplink transmissions towards different TRPs may not be sufficient. The use of a single TA may lead to uplink performance degradation due to inter-symbol interference, for example.

Thus, multiple TAs may be required for a terminal device for multi-TRP operation, and an efficient solution enabling the acquisition and use of multiple TA is needed.

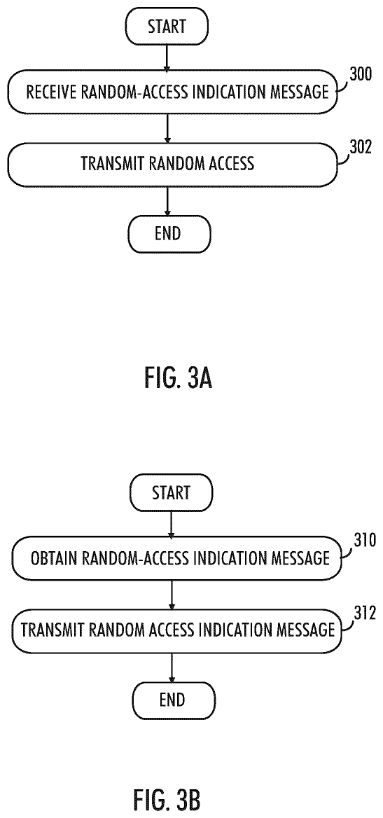

The flowchart of FIG. 3A illustrates an embodiment. The flowchart illustrates an example of the operation of an apparatus. In an embodiment, the apparatus may be a terminal device, user equipment, a part of a terminal device or any other apparatus capable of executing the following steps.

In step 300, the apparatus is configured to receive, from a network entity, a random-access indication message indicating whether a transmission of at least one physical random access channel, PRACH, uses at least one random access resource corresponding to or associated with one or more network entities

In step 302, the apparatus is configured to transmit the at least one of the PRACH based on the random-access indication message.

In an embodiment, the terminal device may receive the random-access indicating message in downlink control information, DCI. In an embodiment, the random-access indicating message may, alternatively or additionally, also be received via medium access control, MAC, control element, CE, or via RRC).

The network entity may be a TRP or a physical cell. Receive from a network entity may include: receive from a transmission-reception point, receive from a physical cell, receive from a control resource set group, or control resource set pool index, for example. The network entity may also be represented by a set of TCI, transmission configuration indicator, states or a set of reference signals (such as SSB(s) and/or CSI-RS(s)).

The flowchart of FIG. 3B illustrates an embodiment. The flowchart illustrates an example of the operation of an apparatus. In an embodiment, the apparatus may be a network entity, TRP, an access point, a physical cell, a gNB, a control resource set group. The apparatus may also be a part of a network entity, a TRP, an access point or a gNB or any other apparatus. The apparatus may be capable of executing the following steps.

In step 310, the apparatus is configured to obtain a random-access indication message.

In step 312, the apparatus is configured to transmit to a terminal device a random-access indication message, wherein the random-access indication message indicates whether a transmission of at least one physical random access channel, PRACH, uses at least one random access resource corresponding to or associated with one or more network entities.

Below, the term TRP may refer to the network entity. However, as one skilled in the art is well aware, the term network entity may be replaced with a physical cell, a gNB, or a control resource set group, or control resource set pool index, for example.

In an embodiment, the DCI may indicate whether the terminal device is to perform a contention-free random access (CFRA) procedure or a contention-based random access (CBRA) procedure.

In an embodiment, the DCI may contain at least one information element to provide indication whether the terminal device should transmit PRACH using random access channel, RACH, resources (RACH occasions and/or preambles) corresponding to or associated with a given TRP. Thus, a single PRACH may be transmitted.

In an embodiment, the DCI may contain at least one information element to provide indication whether the terminal device should transmit PRACH using RACH resources (such as RACH occasions and/or preambles) corresponding to or associated with more than one TRPs. Thus, more than one PRACHs may be transmitted.

For contention-free random access, CFRA, for the case where the DCI indicates the terminal device to transmit two PRACHs, the terminal device may determine that the DCI includes (in addition to a first random-access preamble index a first synchronisation signal/physical broadcast channel, SS/PBCH, index”, and a first random-access channel occasion(s)) further random-access preamble indexes, such as a second preamble index, further SS/PBCH indexes, such as a second SS/PBCH index, and further random access channel occasions, such as a second random-access channel occasion(s), for the more than one transmission. Thus, the terminal device may determine the presence of the other preamble indexes, synchronisation signal block, SSB, indexes, and random-access occasions in DCI.

It's noted that the indication of a second preamble index, a second SSB index, and/or a second random-access channel occasion(s) may be carried using reserved or existing bits/entries in DCI.

It's also noted that the second random-access channel occasion(s), which may be one or more occasions, may not be explicitly indicated in DCI but the terminal device may determine it based on the indicated first random-access channel occasion(s) using some preconfigured rules or associations between first and second random-access channel occasion(s) (corresponding to first and second TRPs).

It's also noted that the indication of a first and second parameter, from the first set and second set of parameters mentioned above, may be carried using codepoint which may indicate two entries (e.g., a first random-access channel occasion(s) and a second random-access channel occasion(s)).

For contention-based random access, CBRA, for the case where the indication indicates the terminal device to transmit one PRACH, the terminal device may be indicated the RACH resources of the TRP of the multi TRPs that are to be used. For example, if the terminal device is configured with RACH resources associated with a first and second TRPs, the terminal device may be indicated through one or more reserved entries/bits in DCI whether to transmit or restrict itself to using the RACH resources, and/or selecting SSB(s), associated to or corresponding to the first or second TRP. This indication may consist of the TRP identifier such as CORESETPool index or PCI.

It may be noted, that as mentioned above a TRP may be represented by a CORESET group (or CORESETPool index) and/or PCI (in case of inter-cell multi-TRP). Hence, in the above examples, a TRP may be replaced by a CORESET group ID and/or by a PCI.

Assume an example situation where a terminal device is configured with two TRPs (as in the example of FIG. 2). One of the benefits of the above examples is that they allow one PDCCH order transmitted from a first TRP to trigger RACH procedure(s) to the same TRP, to a second TRP, or to both TRPs.

Referring to the example of FIG. 2 with two TRPs, regarding the case where the received DCI instructs the terminal device to transmit PRACH utilising RACH resources corresponding to the first TRP or the second TRP, there are some options.

First, for inter-cell beam management, based on at least one information element of the received DCI, the indicated “Random Access Preamble index” in DCI may be associated to either serving cell or non-serving cell (the non-serving TRP that has different PCI than serving cell PCI). This association may be determined based on whether the indicated SSB index is associated with the PCI of the serving cell or with the PCI of the non-serving cell.

Second, for intra/inter-cell multi-TRP case, based on at least one information element of the received DCI, the indicated (if there is only one “Random Access Preamble index” in DCI) or corresponding (if there are two “Random Access Preamble indexes” in DCI) “Random Access Preamble index” in DCI may be associated to a CORESET group, such as either CORESETPoolIndex #0 or CORESETPoolIndex #1, for example.

Referring further to the example of FIG. 2 with two TRPs, regarding the case where received DCI instructs the terminal device that the terminal device should transmit PRACH using RACH resources (e.g., RACH occasions and/or preambles) corresponding to or associated with the two TRPs (or with a single TRP only), there are some options.

First, for inter-cell beam management, based on at least one information element of the received DCI, the indicated “Random Access Preamble index” in DCI may be associated to both serving cell and non-serving cell (the non-serving TRP that has different PCI than serving cell PCI).

Second, for an intra/inter-cell M-TRP, based on at least one information element of the received DCI, the corresponding (if there are two “Random Access Preamble indexes” in DCI) “Random Access Preamble index” in DCI may be associated to two CORESET groups, such as, CORESETPoolIndex #0 and CORESETPoolIndex #1, for example.

It may also be noted that in above examples the second “Random Access Preamble index”/“SS/PBCH index” in DCI may follow a similar design as the first “Random Access Preamble index” in DCI.

It may be further noted that although above examples are described in connection with the two TRP example of FIG. 2, they may be applied in a similar manner if there are more than two TRPs.

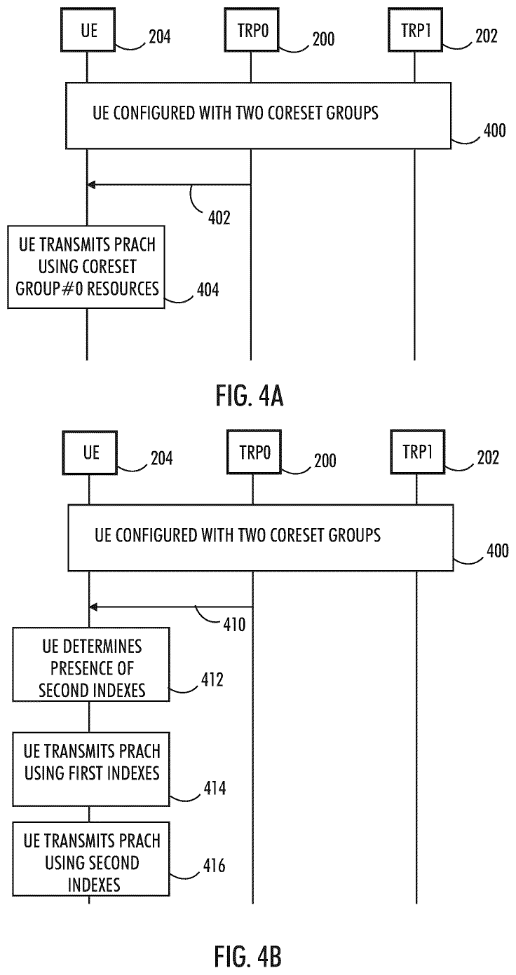

FIG. 4A is a signalling chart illustrating an embodiment. The terminal device 204 is configured 400 with two CORESET groups, CORESET group #0 and CORESET group #1. The terminal device is configured with one set of RACH resources (such as RACH occasions and/or RACH preambles) associated with CORESET group #0 and another set of RACH resources associated with CORESET group #1.

The terminal device 204 receives, for example from TRP0, a random-access indication message 402. The message may be received as DCI. The message indicates whether the terminal device 204 is to transmit PRACH using resources corresponding to CORESET group #0 or CORESET group #1 or both. In this example, the indication is to transmit PRACH using resources corresponding to CORESET group #0 and use contention based random access, CBRA.

The terminal device 204 transmits PRACH based on CBRA by utilising or restricting itself to random-access resources associated to CORESET group #0. It's noted that this may imply that the terminal device may restrict itself to selecting an SSB(s) corresponding to or associated with the random-access resources corresponding to CORESET group #0.

FIG. 4B is a signalling chart illustrating an embodiment. The terminal device 204 is configured 400 with two CORESET groups, CORESET group #0 and CORESET group #1. The terminal device is configured with one set of RACH resources (RACH occasions and/or RACH preambles) associated with CORESET group #0 and another set of RACH resources associated with CORESET group #1.

The terminal device 204 receives, for example from TRP0, a random-access indication message 410. The random-access indication message may be received as DCI alternatively, the message may be received via MAC CE (or even via RRC). The message indicates whether the terminal device 204 is to transmit PRACH using resources corresponding to CORESET group #0 or CORESET group #1 or both. In this example, the indication is to transmit PRACH using resources corresponding to both CORESET group #0 and CORESET group #1. Further, the terminal device is indicated to use contention free random access, CFRA.

The terminal device 204 determines 412 the presence of a second SSB index and second preamble index in the DCI.

The terminal device 204 transmits 414, 416 PRACH based on CFRA utilising resources associated to CORESET group #0, e.g., first indicated SSB index and preamble index and PRACH based on CFRA utilising resources associated to CORESET group #1, e.g., second indicated SSB index and preamble index.

In an embodiment, assuming that the terminal device may be configured with two CORESET groups (or PCIs, TRPs), for example CORESET group #0 and CORESET group #1, each of which associated with a set of RACH resources (such as preamble index RACH occasions), for CBRA the terminal device may be configured to transmit PRACH considering the RACH resources associated to the CORESET group to which the CORESET on which the PDCCH order triggering the RACH procedure is transmitted belongs.

In an embodiment, there may be indication in the DCI whether to transmit the PRACH using the RACH resources (and/or selecting SSB(s)) associated to the CORESET group using which the PDCCH order is transmitted or using the RACH resources associated to the other CORESET group, or whether to transmit (at least) two PRACHs using the RACH resources associated to both CORESET groups.

In an embodiment, if the terminal device is configured with a time alignment timer per TRP (or CORESETPoolIndex or PCI), and this timer expires, the terminal device may trigger random-access procedure by using the RACH resources (and/or selecting SSB(s)) corresponding to or associated with the TRP (or CORESETPoolIndex or PCI) for which the timer has expired.

The proposed solutions described above enable the determination of two TAs for uplink multi-TRP operations and enable one TRP to trigger RACH procedure or PRACH transmission to the same TRP or to another TRP or even to both TRPs for PDCCH order purpose. The proposed solutions reduce downlink overhead due to a single PDCCH order under multi-TRP.

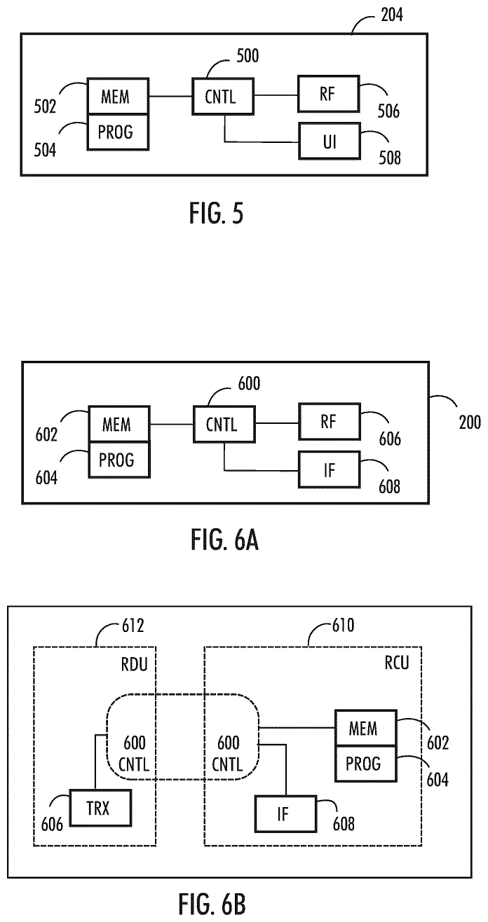

FIG. 5 illustrates an embodiment. The figure illustrates a simplified example of an apparatus applying embodiments of the invention. In some embodiments, the apparatus may be a terminal device, user equipment, or a part of a terminal device or user equipment.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus 204 of the example may include a control circuitry 500 configured to control at least part of the operation of the apparatus.

The apparatus may comprise a memory 502 for storing data. Furthermore, the memory may store software 504 executable by the control circuitry 500. The memory may be integrated in the control circuitry.

The apparatus comprises one or more interface circuitries 506, The interface circuitries may be operationally connected to the control circuitry 500. An interface circuitry 506 may be a set of transceivers configured to communicate with a network entity such as a transmission-reception point, a physical cell, a control resource set group, or a radio access network node, such as an eNodeB or gNB of a wireless communication network. The interfaces circuitries 506 may provide wired or wireless connections. The apparatus may further comprise a user interface 508.

In an embodiment, the software 504 may comprise a computer program comprising program code means adapted to cause the control circuitry 500 of the apparatus to realise at least some of the embodiments described above. FIG. 6A illustrates an embodiment. The figure illustrates a simplified example of an apparatus or network element applying embodiments of the invention. In some embodiments, the apparatus may be a network entity such as a transmission-reception point, a physical cell, a control resource set group, or a radio access network node, such as an eNodeB or gNB of a wireless communication network.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus 200 of the example includes a control circuitry 600 configured to control at least part of the operation of the apparatus.

The apparatus may comprise a memory 602 for storing data. Furthermore, the memory may store software 604 executable by the control circuitry 600. The memory may be integrated in the control circuitry.

The apparatus further comprises one or more transceivers 606, 608 configured to connect the apparatus to other devices and network elements of the radio access network. An interface circuitry 606 may be one or more transceivers configured to communicate with terminal devices or user terminals. An interface circuitry 608 may be one or more transceivers configured to communicate with other network elements such as a core network. The interfaces may provide wired or wireless connections.

In an embodiment, the software 606 may comprise a computer program comprising program code means adapted to cause the control circuitry 600 and transceivers 606, 608 of the apparatus to realise at least some of the embodiments described above.

In an embodiment, as shown in FIG. 6B, at least some of the functionalities of the apparatus of FIG. 6A may be shared between two physically separate devices, forming one operational entity. Therefore, the apparatus may be seen to depict the operational entity comprising one or more physically separate devices for executing at least some of the described processes. Thus, the apparatus of FIG. 6B, utilizing such shared architecture, may comprise a remote control unit RCU 610, such as a host computer or a server computer, operatively coupled (e.g. via a wireless or wired network) to a remote distributed unit RDU 612 located in the base station. In an embodiment, at least some of the described processes may be performed by the RCU 610. In an embodiment, the execution of at least some of the described processes may be shared among the RDU 612 and the RCU 610.

In an embodiment, the RCU 610 may generate a virtual network through which the RCU 610 communicates with the RDU 612. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (e.g. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RDU and the RCU. In practice, any digital signal processing task may be performed in either the RDU or the RCU and the boundary where the responsibility is shifted between the RDU and the RCU may be selected according to implementation.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, processing system or a circuitry which may comprise a working memory (random access memory, RAM), a central processing unit (CPU), and a system clock. The CPU may comprise a set of registers, an arithmetic logic unit, and a controller. The processing system, controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the steps described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst several computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as the technology advances, the inventive concept can be implemented in various ways. The invention and its embodiments are not limited to the examples described above but may vary within the scope of the claims.

1.-24. (canceled)

25. A method for a terminal device, comprising:
receiving, from a network entity, a random-access indication message indicating whether a transmission of at least one physical random-access channel (PRACH) uses a plurality of random-access resources corresponding to or associated with one or more network entities, wherein the plurality of random-access resources comprise the following: random-access preamble index, synchronisation signal/physical broadcast channel, SS/PBCH, index, and random-access channel occasion, wherein the random-access indication message is received in downlink control information (DCI) and via medium access control (MAC) control element, wherein the DCI indicates whether the terminal device is to perform a contention-free random-access (CFRA) procedure or a contention-based random-access (CBRA) procedure, wherein the random-access indicating message comprises an indication of random-access resources to be used for contention-based random-access corresponding to or associated with at least one of the one or more network entities, wherein the random-access indicating message comprises at least a second random-access resource for contention-free random-access corresponding to or associated with at least one of the one or more network entities; and
transmitting the at least one of the PRACH based on the random-access indication message, wherein the transmitted at least one PRACH is using the plurality of random-access resources corresponding to or associated with a network entity for which a corresponding timer has expired.

26. The method of claim 25, wherein the receiving from the network entity comprises receiving from a transmission-reception point.

27. The method of claim 25, wherein the receiving from the network entity comprises receiving from a physical cell.

28. The method of claim 25, wherein the receiving from the network entity comprises receiving over a control resource set group.

29. The method of claim 28, further comprising:
determining a presence of at least one second random-access resource in the message based on an indication carried in the message or based on an indication carried separately.

30. The method of claim 29, wherein the DCI provides an indication to transmit two PRACHs.

31. The method of claim 30, further comprising:
determining that the DCI includes, in addition to a first random-access preamble index a first synchronisation signal/physical broadcast channel (SS/PBCH) index, and a first random-access channel occasions further random-access preamble indexes, further SS/PBCH indexes, and further random-access channel occasions for the transmission.

32. The method of claim 31, further comprising determining a presence of other preamble indexes, synchronisation signal block (SSB) indexes, and random-access occasions in DCI.

33. An apparatus comprising:
a processor; and
a memory comprising computer-executable instructions that, when executed by the processor, cause the apparatus to perform the following operations:
receiving, from a network entity, a random-access indication message indicating whether a transmission of at least one physical random-access channel (PRACH) uses a plurality of random-access resources corresponding to or associated with one or more network entities, wherein the plurality of random-access resources comprise the following: random-access preamble index, synchronisation signal/physical broadcast channel, SS/PBCH, index, and random-access channel occasion, wherein the random-access indication message is received in downlink control information (DCI) and via medium access control (MAC) control element, wherein the DCI indicates whether the terminal device is to perform a contention-free random-access (CFRA) procedure or a contention-based random-access (CBRA) procedure, wherein the random-access indicating message comprises an indication of random-access resources to be used for contention-based random-access corresponding to or associated with at least one of the one or more network entities, wherein the random-access indicating message comprises at least a second random-access resource for contention-free random-access corresponding to or associated with at least one of the one or more network entities; and
transmitting the at least one of the PRACH based on the random-access indication message, wherein the transmitted at least one PRACH is using the plurality of random-access resources corresponding to or associated with a network entity for which a corresponding timer has expired.

34. The apparatus of claim 33, wherein the receiving from the network entity comprises receiving from a transmission-reception point.

35. The apparatus of claim 33, wherein the receiving from the network entity comprises receiving from a physical cell.

36. The apparatus of claim 33, wherein the receiving from the network entity comprises receiving over a control resource set group.

37. The apparatus of claim 36, wherein the computer-executable instructions, when executed by the processor, cause the apparatus to perform the following operations:
determining a presence of at least one second random-access resource in the message based on an indication carried in the message or based on an indication carried separately.

38. The apparatus of claim 29, wherein the DCI provides an indication to transmit two PRACHs.

39. The apparatus of claim 38, wherein the computer-executable instructions, when executed by the processor, cause the apparatus to perform the following operations:
determining that the DCI includes, in addition to a first random-access preamble index a first synchronisation signal/physical broadcast channel (SS/PBCH) index, and a first random-access channel occasions further random-access preamble indexes, further SS/PBCH indexes, and further random-access channel occasions for the transmission.

40. The apparatus of claim 39, wherein the computer-executable instructions, when executed by the processor, cause the apparatus to perform the following operations:
determining a presence of other preamble indexes, synchronisation signal block (SSB) indexes, and random-access occasions in DCI.

41. A system comprising:
an apparatus;
a processor; and
a memory comprising computer-executable instructions that, when executed by the processor, cause the apparatus to perform the following operations:
receiving, from a network entity, a random-access indication message indicating whether a transmission of at least one physical random-access channel (PRACH) uses a plurality of random-access resources corresponding to or associated with one or more network entities, wherein the plurality of random-access resources comprise the following: random-access preamble index, synchronisation signal/physical broadcast channel, SS/PBCH, index, and random-access channel occasion, wherein the random-access indication message is received in downlink control information (DCI) and via medium access control (MAC) control element, wherein the DCI indicates whether the terminal device is to perform a contention-free random-access (CFRA) procedure or a contention-based random-access (CBRA) procedure, wherein the random-access indicating message comprises an indication of random-access resources to be used for contention-based random-access corresponding to or associated with at least one of the one or more network entities, wherein the random-access indicating message comprises at least a second random-access resource for contention-free random-access corresponding to or associated with at least one of the one or more network entities; and
transmitting the at least one of the PRACH based on the random-access indication message, wherein the transmitted at least one PRACH is using the plurality of random-access resources corresponding to or associated with a network entity for which a corresponding timer has expired.

42. The system of claim 41, wherein the receiving from the network entity comprises receiving from a transmission-reception point.

43. The system of claim 42, wherein the computer-executable instructions, when executed by the processor, cause the apparatus to perform the following operations:
determining a presence of at least one second random-access resource in the message based on an indication carried in the message or based on an indication carried separately; and
wherein the DCI provides an indication to transmit two PRACHs.

44. The system of claim 43, wherein the computer-executable instructions, when executed by the processor, cause the apparatus to perform the following operations:
determining that the DCI includes, in addition to a first random-access preamble index a first synchronisation signal/physical broadcast channel (SS/PBCH) index, and a first random-access channel occasions further random-access preamble indexes, further SS/PBCH indexes, and further random-access channel occasions for the transmission.
